(19) United States
(12) Patent Application Publication
(10) Pub. No.: US 2024/0369189 A1
(43) Pub. Date: Nov. 7, 2024

(54) STORAGE DEVICE AND METHOD FOR SUPPLYING A CONSUMER WITH DIFFERENT GAS PRESSURE LEVELS

(71) Applicant: Liebherr-France SAS, Colmar Cedex (FR)

(72) Inventor: Adrien CONREAUX, Wintzenheim (FR)

(21) Appl. No.: 18/653,711

(22) Filed: May 2, 2024

(30) Foreign Application Priority Data
May 5, 2023 (DE) 10 2023 111 786.6

(51) Int. Cl. F17C 7/00

(52) U.S. Cl. CPC F17C 7/00; F17C 2205/0142; F17C 2205/0326; F17C 2205/0335; F17C 2205/0338; F17C 2221/012; F17C 2223/033; F17C 2223/035; F17C 2250/03; F17C 2250/043; F17C 2265/066; F17C 2270/0168; F17C 2270/0545

(57) ABSTRACT

The disclosure relates to a storage device for storing gas and supplying a consumer with different gas pressure levels, comprising at least one low-pressure storage tank and at least one high-pressure storage tank. According to the disclosure, the low-pressure storage tank is connected to a low-pressure connection via a switchable first valve and the high-pressure storage tank is connected to a high-pressure connection via a switchable second valve, wherein it is possible to provide a connected consumer with a higher gas pressure level via the high-pressure connection than via the low-pressure connection. The low-pressure connection and the high-pressure connection are connected to each other via a switchable third valve. Furthermore, the tanks are connected to each other via a fourth valve. The valves are switchable in such a way that the low-pressure storage tank can be emptied to a lower minimum pressure level than the high-pressure storage tank.

### CROSS REFERENCE TO RELATED APPLICATION

The present application claims priority to German Patent Application No. 10 2023 111 786.6 filed on May 5, 2023. The entire contents of the above-listed application are hereby incorporated by reference for all purposes.

### TECHNICAL FIELD

The present disclosure relates to a storage device for storing a gas and for supplying a consumer with different gas pressure levels.

### BACKGROUND

Gas-powered consumers that have several pressure connections and are operated simultaneously at different pressure levels are known from prior art. One example of this is special hydrogen-powered engines for certain working equipment such as stationary or mobile construction machinery. Such consumers are supplied via storage systems that store the gas in one or more pressure vessels and provide the injection pressures (hereinafter also referred to as gas pressure level or simply pressure level) required in each case at the various pressure connections for the consumer.

### SUMMARY

The gas is typically supplied to the consumer via a pressure differential, i.e. the gas is stored in the storage system at a higher pressure than the injection pressure for the consumer. Pressure reducers ensure that the gas is supplied to the consumer at the correct pressure at the respective connections. Gas is supplied until the pressure of the gas stored in the storage system equals or falls below the injection pressure at one of the connections. For this reason, the storage system is never completely emptied. All the gas that remains in the storage tank(s) and the pressure lines of the storage system when the minimum pressure at which the consumer can still be operated is reached is therefore unusable and is referred to below as “dead mass”.

For consumers that are operated at two different pressure levels, the simplest solution is to supply both pressure connections for the consumer (referred to below as low-pressure connection and high-pressure connection, as one of the two connections provides a higher pressure level than the other) through all existing gas storage tanks via a common supply circuit. However, this results in a comparatively large dead mass, as a supply can only be provided until the higher of the two pressure levels provided to the consumer is reached. This results in less efficient operation of the consumer.

Therefore, it is the object underlying the present disclosure to provide a gas storage system with a reduced dead mass, which enables more efficient operation of a connected consumer. In particular, this is to be made possible without having to accept a considerably larger dimensioning of the storage system.

According to the disclosure, this object is achieved is by a storage device as described herein.

Accordingly, according to a first aspect of the present disclosure, a storage device for storing a gas and for supplying a consumer with different gas pressure levels or injection pressures is proposed, which comprises at least one low-pressure storage tank and at least one high-pressure storage tank. The consumer may be a gas engine. The gas can be hydrogen or any other gas.

Whenever the term “the” low-pressure storage tank” or “the” high-pressure storage tank” is used in the following, this always refers to at least one low-pressure storage tank or at least one high-pressure storage tank, i.e. one or more low-pressure or high-pressure storage tanks.

According to the disclosure, the storage device has the following structure:

The low-pressure storage tank is connected to a low-pressure connection via a switchable first valve and the high-pressure storage tank is connected to a high-pressure connection of the storage device via a switchable second valve. In the present case, the term “switchable valve” means that the valve can be actively switched and the connections of the valve can be connected to each other in a gas-conducting manner or separated from each other in a gas-tight manner.

A higher gas pressure level or a higher injection pressure can be provided to a connected consumer via the high-pressure connection than via the low-pressure connection. The low-pressure connection provides a first gas pressure level and the high-pressure connection provides a second gas pressure level above the first gas pressure level. The low-pressure connection is connected to the high-pressure connection via a switchable third valve. In other words, depending on the switch position of the third valve, the low-pressure and high-pressure connections (hereinafter also referred to together only as the connections) can be connected to each other in a gas-conducting manner or separated from each other in a gas-tight manner.

The low-pressure storage tank is connected to the high-pressure storage tank via a fourth valve. The fourth valve can be switchable actively or passively (e.g. in the type of a non-return valve).

According to the disclosure, the switchable valves are arranged and can be switched in such a way that the low-pressure storage tank can be emptied to a lower minimum pressure level than the high-pressure storage tank. This lower minimum pressure level corresponds in particular to the first gas pressure level that can be provided by the low-pressure connection.

The present disclosure is based on the knowledge that the dead mass of the storage device can be reduced if the number of gas storage tanks that can only be emptied to the higher gas pressure level present at the consumer (i.e. the gas pressure level provided via the high-pressure connection) is reduced. This corresponds to a reduction in the volume of gas that cannot be used at the higher gas pressure level.

This means that not all gas storage tanks (or a single, shared gas storage tank) are used permanently to supply both the low-pressure and the high-pressure connection, but as many gas storage tanks as possible (optionally N−1 gas storage tanks if a total of N gas storage tanks are used) are emptied to the lower gas pressure level at the consumer (i.e. down to the gas pressure level provided at the low-pressure connection). At the lower gas pressure level, the remaining dead mass has a smaller volume. As a result, more efficient operation of the consumer can be achieved without having to provide a significantly larger or more complex supply system.

In the present case, the terms low-pressure storage tank and high-pressure storage tank should not be understood to mean that they store the gas at different pressures (although this would certainly be possible with the device according to the disclosure), but rather serve to differentiate these pressure storage tanks linguistically. In particular, the at least one low-pressure storage tank can be emptied to a lower minimum pressure level than the at least one high-pressure storage tank.

The first, second and/or third valves can be configured as Black-white valves with two switching positions (open, closed), as valves with more than two discrete switching positions or as proportional valves.

In one possible embodiment, the storage device further comprises a first pressure reducing valve connected to the low-pressure connection and a second pressure reducing valve connected to the high-pressure connection. The pressure reducing valves (hereinafter also referred to simply as pressure reducers) provide defined injection pressures or gas pressure levels at the low-pressure and high-pressure connections for a connected consumer. Here, the first pressure reducing valve at the low-pressure connection provides a defined first gas pressure level, which is lower than a second gas pressure level provided via the second pressure reducing valve at the high-pressure connection. The connected consumer is therefore supplied or driven via two different gas pressure levels.

In a further possible embodiment, the fourth valve is a non-return valve which separates a low-pressure area formed between the low-pressure storage tank and the first valve from a high-pressure area formed between the high-pressure storage tank and the second valve. The terms low-pressure area and high-pressure area, like the terms low-pressure storage tank and high-pressure storage tank, should not be understood to mean that there is always a lower pressure in the low-pressure area than in the high-pressure area, but rather indicate that the low-pressure storage tank or area can be emptied to a lower minimum pressure level than the high-pressure storage tank or area. The non-return valve is configured to block the flow of gas from the high-pressure area to the low-pressure area. In particular, the non-return valve opens when the pressure in the low-pressure area is higher than in the high-pressure area and blocks in the opposite case.

In a further possible embodiment, it is provided that the low-pressure and high-pressure storage tanks are connected to a common gas inlet and can be filled with gas together via this inlet. Optionally, the gas inlet is connected to a low-pressure area formed between the low-pressure storage tank and the first valve. The fourth valve is optionally configured to open when filling with gas and to connect the low- and high-pressure storage tanks (or the low- and high-pressure areas) to each other in a gas-conducting manner.

In particular, the fourth valve is configured as a non-return valve with the above-specified blocking direction, so that it opens automatically when gas with a certain pressure is introduced into the low-pressure area via the gas inlet. This allows the storage device to be filled quickly and easily. Alternatively, the fourth valve could also be actively switchable and automatically switched by a control unit. Alternatively, the fourth valve could be configured as a manually operated shut-off valve so that the fourth valve is switched manually rather than automatically.

According to a second aspect of the present disclosure, a storage device for storing a gas and for supplying a consumer with different gas pressure levels (or injection pressures or simply pressure levels) is proposed, which comprises at least one low-pressure storage tank and at least one high-pressure storage tank, wherein it is provided in accordance with the disclosure that the low-pressure storage tank is connected to a low-pressure connection via a switchable first valve and the high-pressure storage tank is connected to a high-pressure connection via a switchable second valve, wherein it is being possible, as in the first aspect, to provide a connected consumer with a higher second gas pressure level via the high-pressure connection than via the low-pressure connection, which provides a first gas pressure level. The low-pressure storage tank and the high-pressure storage tank are connected to each other via a third valve. The third valve can be an actively switchable valve or a non-return valve.

The valves are switchable in such a way that the low-pressure storage tank can be emptied to a lower minimum pressure level (which corresponds in particular to the first gas pressure level) than the high-pressure storage tank. This results in the same advantages and properties as for the storage device according to the first aspect, wherein an alternative valve assembly is used here. The statement that the valves are switchable is to be understood with regard to the third valve as meaning that this can involve active switching or (if it is a non-return valve) passive switching (by means of a corresponding pressure difference).

In a possible embodiment of the storage device according to the second aspect, it is provided that the low-pressure connection and the high-pressure connection are only connected to each other via the third valve. In other words, there is no further connection between the two connections, in particular no further connection with a bypass valve. If the third valve is therefore switched to the shut-off position (active or passive), the high-pressure and low-pressure connections are separated from each other in a gas-tight manner. In this case, the low-pressure connection is only supplied by the low-pressure storage tank and the high-pressure connection is only supplied by the high-pressure storage tank, so that there are effectively two separate supply circuits. When the third valve is open, the low-pressure and high-pressure areas are connected to each other in a gas-conducting manner, for example to fill the gas storage tanks with gas via a common gas inlet as described in the first aspect. The third valve can be an actively switchable valve or a non-return valve.

The possible embodiments described below may relate both to the storage device according to the first aspect and the storage device according to the second aspect.

In a further possible embodiment, it is provided that a first pressure sensor is arranged in the low-pressure area, which detects the pressure level (hereinafter also referred to simply as pressure) in the low-pressure area, and a second pressure sensor is arranged in the high-pressure area, which detects the pressure level in the high-pressure area. The detected pressures can be used for switching or actuating the switchable valves in order to connect (or disconnect) the high and low-pressure connections to the high and low-pressure storage tanks depending on the detected pressure level in the high and low pressure areas in such a way that optimum emptying of the various gas storage tanks is achieved with optimum reduction of the dead mass.

In a further possible embodiment, it is provided that the storage device further comprises a control unit which is connected to the switchable first, second and third valves and is configured to switch them independently of one another. The first, second and third valves can be electrically actuated and in particular be configured as solenoid valves. In this way, fully automatic control of the storage device according to the disclosure can be realized in order to ensure optimum utilization of the storage capacities and efficient operation of the consumer. With regard to the second aspect, the above only applies in the event that the third valve connecting the low- and high-pressure storage tank is configured as an actively switchable valve. If the third valve is configured as a non-return valve, the above statements with regard to switching the valves only apply to the first and second valves.

In a further possible embodiment, it is provided that the control unit is connected to the first and second pressure sensors and is configured to automatically switch the first, second and third valves depending on the pressures detected via the pressure sensors such that, with simultaneous pressure supply to the low and high-pressure connections, the low-pressure storage tank is emptied to a first minimum pressure level and the high-pressure storage tank is emptied to a second minimum pressure level, wherein the second minimum pressure level is higher than the first minimum pressure level. In particular, the first minimum pressure level corresponds to the first gas pressure level provided at the low-pressure connection and the second minimum pressure level corresponds to the second gas pressure level provided at the high-pressure connection. With regard to the second aspect, the above only applies in the event that the third valve connecting the low and high-pressure storage tanks is configured as an actively switchable valve. If the third valve is configured as a non-return valve, the above statements with regard to switching the valves only apply to the first and second valves.

In a further possible embodiment, it is provided that the first and second valves and/or the first and second pressure reducing valves are configured such that a gas flow through the first valve is greater than a gas flow through the second valve. In an embodiment of the storage device according to the first aspect, in which a non-return valve is arranged between the low and high pressure areas, the lower gas flow through the second valve ensures that a higher pressure prevails in the high pressure area than in the low pressure area and the non-return valve remains closed.

The present disclosure also relates to a working equipment with a storage device according to the disclosure and a consumer supplied by said device with two different injection pressures or gas pressure levels, which has a low-pressure inlet connected to the low-pressure connection of the storage device and a high-pressure inlet connected to the high-pressure connection of the storage device. This obviously has the same advantages, properties and possible embodiments as the storage device according to the disclosure, which is why a repetitive description is omitted at this point.

The consumer may be a gas engine, in particular a hydrogen-powered engine. The working equipment can be a construction machine such as an excavator, a crane (stationary or mobile), a dump truck, a deep foundation machine such as a slurry wall cutter, rotary drilling rig or vibratory pile driver, a concrete pump or any other construction machine with a gas-powered engine.

The present disclosure also relates to a method for supplying a consumer, in particular a gas-powered engine, with different gas pressure levels by means of a storage device according to the disclosure. Here, a first pressure is measured in the low-pressure range and a second pressure is measured in the high-pressure range and, depending on the measured pressures, the switchable valves are switched in such a way that the low-pressure storage tank can be emptied to a first minimum pressure level and the high-pressure storage tank can be emptied to a second minimum pressure level, wherein the second minimum pressure level is higher than the first minimum pressure level. This obviously results in the same advantages, properties and possible embodiments as for the storage device according to the disclosure, which is why a repetitive description is dispensed with at this point. In particular, the first minimum pressure level corresponds to the first gas pressure level provided at the low-pressure connection and the second minimum pressure level corresponds to the second gas pressure level provided at the high-pressure connection.

In one possible embodiment of the method according to the disclosure, it is provided that the storage device is configured according to the first aspect, wherein the first and second valves are opened and the third and fourth valves are closed when the first measured pressure is greater than the first minimum pressure level (first stage). This allows the low-pressure storage tank to be emptied to the first minimum pressure level. If the first measured pressure is less than or equal to the first minimum pressure level (second stage), however, the second and third valves are open and the first and fourth valves are closed so that the high-pressure storage tank can be emptied to the second minimum pressure level. Optionally, the low-pressure and high-pressure connections are supplied simultaneously.

In this solution, a reduction in the dead mass is achieved by enabling the low-pressure storage tank to be emptied to the lower first minimum pressure level using the third valve acting as a bypass valve. Several low-pressure storage tanks can be provided, all of which are arranged in the low-pressure range and are therefore all emptied to the first minimum pressure level. A single high-pressure storage tank can be provided. If a total of N gas storage tanks are provided, the N−1 low-pressure storage tanks can be emptied to the first minimum pressure level, while only the one high-pressure storage tank is emptied to the higher second minimum pressure level. Alternatively, more than one high-pressure storage tank can be provided.

In the first stage, the low-pressure storage tank supplies the low-pressure connection, as the pressure in the low-pressure range is above the first gas pressure level. The high-pressure storage tank supplies the high-pressure connection. As the third and fourth valves are closed, the low and high pressure areas are separated from each other so that the low and high-pressure connections are supplied via two separate circuits. Optionally, the mass flow via the second valve is lower than via the first valve. In this case, the fourth valve can be configured as a non-return valve, which remains closed due to the higher pressure in the high-pressure area.

If the measured first pressure (low-pressure range) reaches the first minimum pressure level, the low-pressure storage tank is considered to be empty. The third valve, which acts as a bypass valve, is now opened so that in the second stage the high-pressure storage tank supplies both the high-pressure connection and the low-pressure connection. For this purpose, the high-pressure storage tank, the first and second valves and/or the first and second pressure reducing valves are configured in particular so that the pressure in the high-pressure area is still above the second gas pressure level after the low-pressure storage tank has been emptied. The supply via the high-pressure storage tank continues until the pressure in the high-pressure area reaches the second minimum pressure level or the second gas pressure level that can be provided at the high-pressure connection and the high-pressure storage tank is therefore also emptied.

In an alternative possible embodiment of the method according to the disclosure, it is provided that the storage device is configured according to the first aspect. In this embodiment, the first, second and third valves are open in the first stage and the fourth valve may be closed, wherein the first stage is characterized in that the first measured pressure is greater than a defined intermediate pressure level, which is in particular above the second minimum pressure level. The low and high-pressure storage tanks jointly supply the low and high-pressure connections and are emptied to the intermediate pressure level. If the first measured pressure is less than or equal to the intermediate pressure level (second stage), the first and second valves are open and the third and fourth valves are closed, so that the high and low pressure areas are separated from each other and the high and low-pressure storage tanks only supply the high and low-pressure connections respectively. This allows the low-pressure storage tank to be emptied to the first minimum pressure level and the high-pressure storage tank to be emptied separately to the second minimum pressure level.

This achieves the same result as in the above-described embodiment by switching the valves differently. For this purpose, the intermediate pressure level must be suitably selected, wherein the value of the intermediate pressure level depends on the design of the components (gas storage tank, valves, pressure reducer) of the storage device. Optionally, the intermediate pressure level is selected such, that the high and low-pressure storage tanks reach their respective minimum pressure levels at the same time.

In an alternative possible embodiment of the method according to the disclosure, it is provided that the storage device is configured according to the first aspect, wherein the first and third valves are open and the second and fourth valves are closed when the first measured pressure is greater than the second minimum pressure level (first stage). In this case, the low-pressure storage tank supplies both the low-pressure connection and the high-pressure connection in the first stage and can be emptied to the second minimum pressure level. In the first stage, the high-pressure storage tank does not supply either of the connections. If the first measured pressure is less than or equal to the second minimum pressure level (second stage), however, the first and second valves are open and the third and fourth valves are closed, so that the high and low pressure areas are separated from each other and the high and low-pressure storage tanks each only supply the high or low-pressure connection. This allows the low-pressure storage tank to be emptied to the first minimum pressure level and the high-pressure storage tank to the second minimum pressure level.

Here too, the same result is achieved by switching the valves differently as in the two embodiments described above. Optionally, multiple low-pressure storage tanks and/or multiple high-pressure storage tanks are provided, which have different capacities and are configured in such a way that the high-pressure and low-pressure storage tanks reach their respective minimum pressure levels simultaneously in the second stage. The valves and/or pressure reducing valves must also be configured accordingly, in particular with regard to the mass flows through the first and second valves. Alternatively, only one low-pressure storage tank and only one high-pressure storage tank can be provided, which, however, have different capacities.

In an alternative possible embodiment of the method according to the disclosure, it is provided that the storage device is configured according to the second aspect of the present disclosure, wherein the first and second valves are open and the third valve is closed, so that the low-pressure storage tank can be emptied to the first minimum pressure level and the high-pressure storage tank can be emptied separately up to the second minimum pressure level. Because the third valve is closed, the high and low pressure areas are separated from one another and the high and low-pressure storage tanks only supply the high and low-pressure connections respectively.

Optionally, several low-pressure storage tanks and/or several high-pressure storage tanks are provided, which have different capacities and are configured in such a way that the high-pressure and low-pressure storage tanks reach their respective minimum pressure levels simultaneously. The first and second valves and/or the first and second pressure reducing valves must also be configured accordingly, in particular with regard to the mass flows through the first and second valves. Alternatively, only one low-pressure storage tank and only one high-pressure storage tank can be provided in each case, but these have different capacities in particular.

The method according to the disclosure according to any one of the embodiments described above can comprise both stages or only one of the two stages. For example, the method could be started with a partially emptied storage device, so that the switchable valves are switched directly to the switching position of the second stage (or are already switched in this way). The method according to the disclosure does not have to be carried out until the high-pressure storage tank or the low-pressure storage tank is completely empty, but can be terminated after the consumer has been operated and the storage device has not yet been emptied. The method according to the disclosure can of course also comprise a supply of the consumer via the first and second stages until the storage device is completely emptied (possibly also a prior and/or subsequent filling of the storage device), whereby the operation of the consumer need not be continuous, but can comprise several stages of inactivity.

### BRIEF DESCRIPTION OF THE FIGURES

Further features, details and advantages of the disclosure result from the exemplary embodiments explained below with reference to the Figures. The Figures show in:

FIGS. 1a-d: an example of a storage device known from the prior art, showing different stages of the gas supply and a flow diagram (FIG. 1d);

FIGS. 2a-d: a first exemplary embodiment of the storage device according to the disclosure, showing different stages of the gas supply;

FIG. 2e: a flow diagram of a method carried out by means of the storage device according to FIGS. 2a-d;

FIGS. 3a-b: a second exemplary embodiment of the storage device according to the disclosure, showing different stages of the gas supply;

FIG. 3c: a flow diagram of a method carried out by means of the storage device according to FIGS. 3a-b;

FIGS. 4a-c: a third exemplary embodiment of the storage device according to the disclosure;

FIG. 4d: a flow diagram of a method carried out by means of the storage device according to FIGS. 4a-c;

FIGS. 5a-d: a fourth exemplary embodiment of the storage device according to the disclosure, wherein different stages of the gas supply are shown; and

FIG. 5e: a flow diagram of a method carried out by means of the storage device according to FIGS. 5a-d.

### DETAILED DESCRIPTION

The total mass M_{T} of the gas in the storage device is calculated as follows:

$${M}_{T} = {M}_{U} + {M}_{D} , \qquad ( 1 )$$

wherein M_{U} stands for the mass usable by the consumer and M_{D} stands for the mass or dead mass of the gas that cannot be used by the consumer.

The usable mass M_{U} depends on the required autonomy of the consumer. The dead mass M_{D} should be minimized in every system, as it cannot be used to drive the consumer. In the case of a gas-powered motor, which operates at two different pressure levels P_{low} and P_{high} a certain part of the stored gas is unusable at the lower pressure level, while a certain P_{low} level, while a certain other part of the stored gas is unusable at the higher pressure level. P_{high} is unusable. Therefore, for each pressure level P_{low} and P_{high} an associated dead mass:

$${M}_{D} = ρ ( {P}_{low} , {T}_{0} ) \cdot {V}_{Plow} + ρ ( {P}_{high} , {T}_{0} ) \cdot {V}_{Phigh} , \qquad ( 2 )$$

$${V}_{Plow} + {V}_{Phigh} = {V}_{T} . \qquad ( 3 )$$

Here ρ (P,T) denotes the density of the gas at a pressure P and a temperature T, V_{Plow} the volume of gas unusable at a pressure P_{low} (i.e. the volume of the dead mass at pressure P_{low}) and V_{Phigh} the volume of gas unusable at a pressure P_{high} (i.e. the volume of the dead mass at pressure P_{high}), where P_{low}<P_{high}. V_{T} denotes the total gas volume of the storage device.

Since a gas has a lower density at a lower pressure (at the same temperature), it results from equations (2) and (3) that the absolute minimum and maximum dead masses M_{D,min} and M_{D,max} result as follows:

$$( {V}_{Phigh} = 0 ) \to {M}_{D , min} = ρ ( {P}_{low} , {T}_{0} ) \cdot {V}_{T} , \qquad ( 5 )$$

$$( {V}_{Plow} = 0 ) \to {M}_{D , max} = ρ ( {P}_{high} , {T}_{0} ) \cdot {V}_{T} . \qquad ( 6 )$$

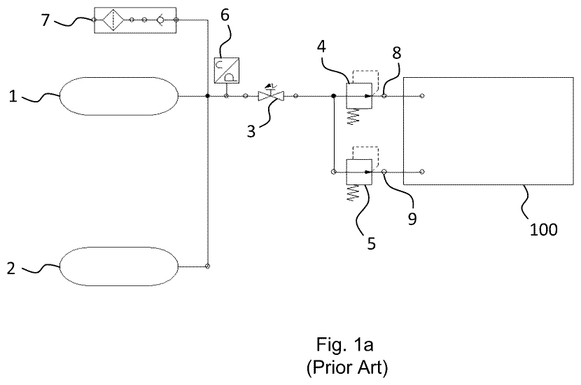

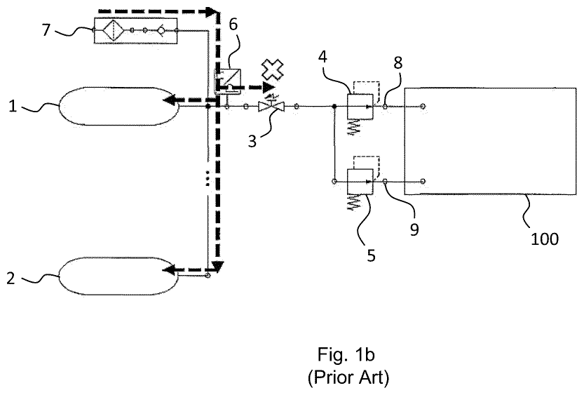

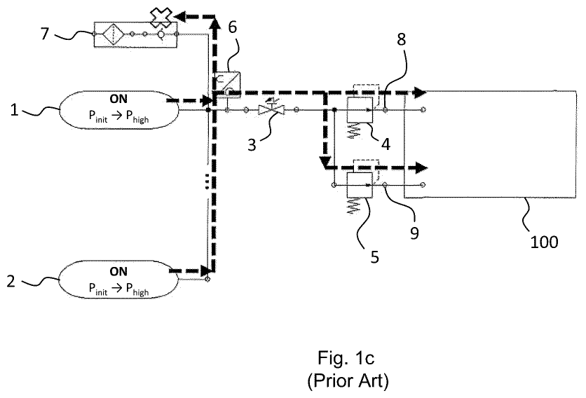

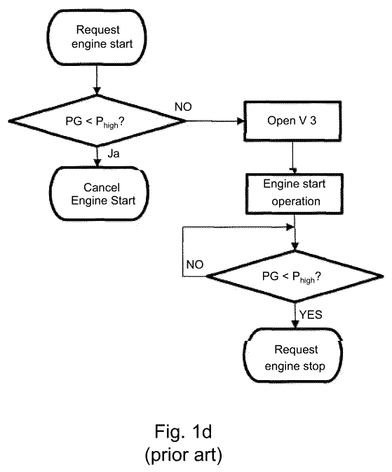

For consumers that are operated at two different pressure levels or injection pressures, the simplest solution is to feed the low and high-pressure connections via a single supply circuit from one or more common gas storage tanks. An example of such a known system is shown in FIG. 1a as a schematic circuit diagram. The storage device comprises two gas storage tanks 1, 2, which are connected to the two connections 8, 9 for the consumer 100 (e.g. a gas engine) via a switchable valve 3 (which is shown here as a solenoid valve). One of the connections (e.g. connection 8) provides a lower pressure level than the other connection 9, so that the former can be referred to as low-pressure connection 8 and the latter as high-pressure connection 9. Both connections 8, 9 are supplied via a single circuit through both gas cylinders 1, 2.

In order to provide a defined pressure level at the connections 8, 9, to which the consumer 100 is connected via corresponding low and high pressure inlets, pressure reducers 4, 5 are provided, which reduce the system pressure to the respective pressure level. A pressure sensor 6 detects the pressure in the area between the valve 3 and the gas storage tanks 1, 2. There can be more than two gas storage tanks. Gas storage tanks 1, 2 can be filled with gas via a common gas inlet 7, wherein valve 3 is closed for this purpose. This is shown in FIG. 1b, wherein the gas flow is shown as dashed arrows in this and all subsequent Figures. The closed switching position of valve 3 is indicated by a cross (also in the other Figures). FIG. 1c shows the state of the gas supply to the consumer 100. For this purpose, valve 3 is open, while a non-return valve in the gas inlet 7 ensures that it is closed and gas does not escape.

FIG. 1d shows a flow diagram for the supply of a consumer 100 configured as a gas engine with the storage device according to FIG. 1a-c. Here, “PG” denotes the pressure detected by the pressure sensor 6 and “V 3” denotes the valve 3.

The gas pressure in the storage device after filling is referred to as Pᵢₙᵢₜ (initial pressure). As both connections 8, 9 are supplied via the same supply circuit, the storage device as a whole is considered to be empty when the pressure measured by the pressure sensor 6 reaches the higher of the two pressure levels provided at the connections, that is, P_{high}. However, this results in a comparatively large dead mass according to equation (6), as a supply can only be provided until the higher pressure level is reached. P_{high} can take place.

The idea according to the disclosure is to reduce the unusable gas volume at the pressure level provided at the high-pressure connection. P_{high} useless gas volume V_{Phigh} in the storage device at the pressure level provided at the high-pressure connection so that the dead mass approximates equation (5).

Four exemplary embodiments of the storage device 10 according to the disclosure are described below. Identical components are denoted with the same reference characters in the various exemplary embodiments.

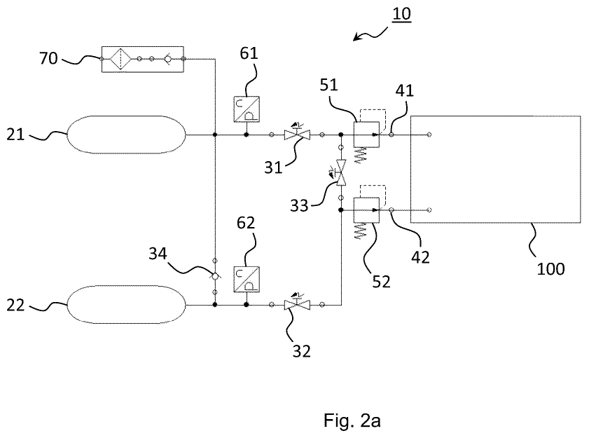

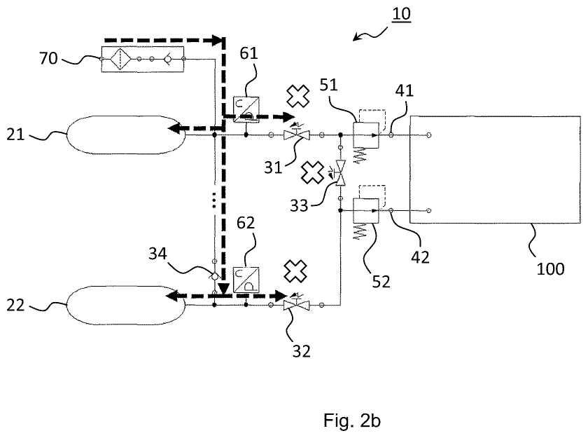

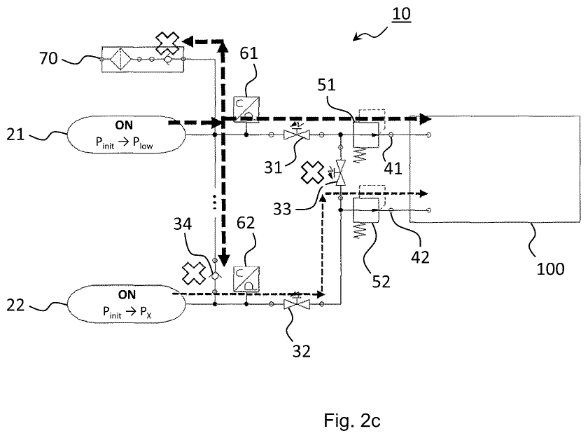

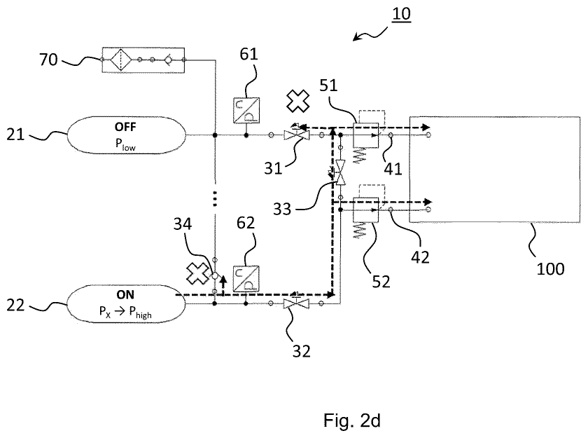

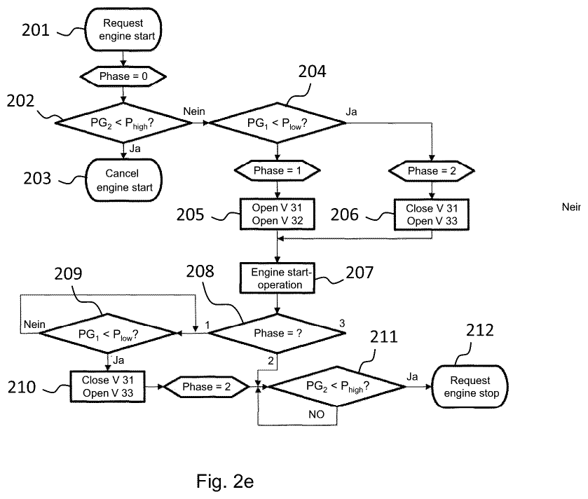

FIGS. 2a-d show a first exemplary embodiment, with FIG. 2a showing the structure of the storage device 10, FIG. 2b showing the filling method and FIGS. 2c-d showing the two stages of supplying the consumer 100.

The storage device 10 according to the disclosure comprises a gas inlet 70 for filling the gas storage tanks 21, 22, which has the structure and the same function as described with respect to FIG. 1a. The storage device 10 comprises a low-pressure connection 41, upstream of which a first pressure reducer 51 is connected in order to provide a defined first gas pressure level P_{low}. The storage device 10 also comprises a high-pressure connection 42, which has second pressure reducer 52 connected upstream in order to provide a defined second gas pressure level P_{high}, which is higher than the first gas pressure level P_{low}. The consumer 100 has corresponding low and high pressure inlets which are connected to the low and high-pressure connections 41, 42 of the storage device 10.

In this exemplary embodiment, the storage device 10 comprises a low-pressure storage tank 21 and a high-pressure storage tank 22, which may have identical or different capacities. The low-pressure storage tank 21 is connected to the low-pressure connection 41 via a switchable first valve 31, wherein the first pressure reducer 51 is connected between the first valve 31 and the low-pressure connection 41. The high-pressure storage tank 22 is connected to the high-pressure connection 42 via a switchable second valve 32, wherein the second pressure reducer 52 is connected between the second valve 32 and the high-pressure connection 42.

The supply line that connects the first valve 31 to the first pressure reducer 51 is connected via a bypass line to the supply line that connects the second valve 32 to the second pressure reducer 52. A switchable third valve 33 is arranged in this bypass line, which in an open state connects the low-pressure connection 41 to the high-pressure connection 42. The third valve 33 thus functions as a bypass valve, the function of which is described below.

Parallel to the bypass line, the low-pressure storage tank 21 and the high-pressure storage tank 22 are connected to each other via a fourth valve 34, which in this exemplary embodiment is configured as a non-return valve. The area between the fourth valve 34, the low-pressure storage tank 21 and the first valve 31 forms a low-pressure area of the storage device 10. The area between the fourth valve 34, the high-pressure storage tank 22 and the second valve 32 forms a high-pressure area of the storage device 10. The low-pressure area is therefore separated from the high-pressure area by the fourth valve 34. Its blocking direction is set in such a way that it opens when the pressure in the low-pressure area exceeds the pressure in the high-pressure area, and connects the low-and high-pressure areas in a gas-conducting manner. In an alternative embodiment, the fourth valve 34 could be configured as an actively switchable valve. A design as a manually switchable shut-off valve is also conceivable in principle.

A first pressure sensor 61 is located in the low-pressure area between the low-pressure storage tank 21 and the first valve 31 and detects the pressure level currently prevailing in the low-pressure area. A second pressure sensor 62 is located in the high-pressure area between high-pressure storage tank 22 and second valve 32 and detects the pressure level currently prevailing in the high-pressure area.

Depending on the switching state of the valves 31, 32, 33, 34, the low and high-pressure connections 41, 42 can therefore be supplied with gas via a common supply circuit or via two separate supply circuits.

Optionally, the pressure sensors 61, 62 and the switchable valves 31, 32, 33 are electrically connected to a control unit, not shown in the Figures, which electrically actuates the valves 31, 32, 33 depending on the detected pressures.

FIG. 2b shows the method of filling the storage device 10 with gas via the gas inlet 70. For this purpose, the first and second valves 31, 32 and, if applicable, the third valve 33 are closed. The pressure introduced via the gas inlet 70 opens the non-return valve 34 so that all gas storage tanks 21, 22 can be filled via the common gas inlet 70. After filling the storage device 10, an initial pressure prevails in the low and high pressure areas Pᵢₙᵢₜ.

FIGS. 2c-d show two stages of the supply operation of the storage device 10 for the consumer 100, which allows the low-pressure storage tank 21 to be emptied to a lower minimum pressure level than the high-pressure storage tank 22, which is emptied to a higher minimum pressure level. The lower minimum pressure level corresponds to the first gas pressure level provided via the first pressure reducer 51 at the low-pressure connection 41 P_{low} and the higher minimum pressure level corresponds to the second gas pressure level provided via the second pressure reducer 52 at the high-pressure connection 42 P_{high}.

In a first stage, which is shown in FIG. 2c, the low-pressure connection 41 is only supplied via the low-pressure storage tank 21 and the high-pressure connection 42 only via the high-pressure storage tank 22. For this purpose, the first and second valves 31, 32 are open and the third valve 33 is closed. The first and second pressure reducers 51, 52 are configured so that the mass flow through the second pressure reducer 52 or through the second valve 32 is less than that through the first pressure reducer 51 or the first valve 31. As a result, the high-pressure storage tank 22 discharges more slowly than the low-pressure storage tank 21, wherein the non-return valve 34 remains closed due to the higher pressure in the high-pressure area. Alternatively or additionally, the difference in mass flow could also be produced by a correspondingly different design of the first and second valves 31, 32.

This switching state according to the first stage is maintained until the pressure detected by the first pressure sensor 61 PG₁ in the low pressure range reaches the first pressure level P_{low} generated by the first pressure reducer 51 is reached. In the first stage, the low-pressure storage tank 21 is therefore emptied to the first minimum pressure level P_{low} and the high-pressure storage tank 22 is emptied to a predetermined intermediate pressure P_{X} wherein the value of P_{X} depends on the capacity of the low-pressure storage tank 21 (or the number of low-pressure storage tanks 21). The low-pressure storage tank 21 is now completely emptied.

The storage device 10 now enters a second stage, which is shown in FIG. 2d. In the second stage, the first valve 31 is closed, while the third valve 33 is open and connects the two connections 41, 42 to one in a gas-conducting manner. The non-return valve 34 remains closed due to the pressure difference between the low and high pressure ranges. The second valve 32 also remains open. As a result, both connections 41, 42 are now supplied via the high-pressure storage tank 22, which is emptied to the second minimum pressure level P_{high} provided by the second pressure reducer 52 at the high-pressure connection 42 is emptied. If the detected pressure PG₂ in the high pressure range reaches the value P_{high} the high-pressure storage tank 22 is considered to be emptied.

The values of P_{X}, P_{low} and P_{high} are optionally stored in the above-mentioned control unit.

By allowing the low-pressure storage tank 21 to be emptied to the lower minimum pressure level P_{low} and only the high-pressure storage tank 22 is only emptied to the higher minimum pressure level P_{high} the dead mass of the storage device 10 can be reduced in total.

The storage device 10 may comprise a plurality of gas storage tanks 21, 22, for example a number of N gas storage tanks 21, 22, wherein N−1 low-pressure storage tanks 21 and one high-pressure storage tank 22 may be provided. In this case, all N−1 low-pressure storage tanks 21 are emptied to the lower pressure level P_{low}.

FIG. 2e uses a flow diagram to show an embodiment of a method for operating the consumer 100, which is configured as a gas engine, using the storage device of FIGS. 2a-d. The flow diagram does not take into account the start and stop functions of the engine 100. Here (and in the flow diagrams of the following embodiments) PG₁ the pressure level detected by the first pressure sensor 61 and PG₂ the pressure level detected by the second pressure sensor 62. The valves 31, 32, 33 are referred to as “V 31”, “V 32”, and “V 33”. This designation also applies to the flow diagrams of the other embodiments.

After a request for an engine start (step 201), it is checked (in particular by the aforementioned control unit) whether the pressure level PG₂ is above the second minimum pressure level P_{high} (step 202). If not, the storage device 10 or the high-pressure storage tank 22 is considered to be empty and the engine start is aborted (step 203). If yes, it is checked whether the pressure level PG₁ is above the first minimum pressure level P_{low} (step 204). If so, the pressure in the low-pressure storage tank 21 is sufficient to supply the low-pressure connection 41 (stage 1) and the first and second valves 31, 32 are opened (step 205), while the third and fourth valves 33, 34 remain closed. If the pressure level PG₁ is not greater than the first minimum pressure level P_{low}, the low-pressure storage tank 21 is to be regarded as emptied and the supply to the motor 100 takes place in stage 2, i.e. the third valve or bypass valve 33 is opened while the first valve 31 is closed (step 206). Thus, both connections 41, 42 are supplied via the high-pressure storage tank 22 until the latter is also emptied. After switching the corresponding valves 31, 32, 33 (step 205 or 206), the engine 100 is started (step 207) and this is supplied with the corresponding injection pressures. Checking the pressure levels PG₁ and PG₂ can be carried out simultaneously.

During engine operation, the pressures PG₁ and PG₂ are recorded and compared with the corresponding limit values P_{low} and P_{high} depending on which stage the system is in (step 208). If the supply takes place in stage 1, the pressure level is PG₁ is monitored (step 209). If the pressured drops to PG₁ or below the first minimum pressure level P_{low} (low-pressure storage tank 21 emptied), the system switches to stage 2 and the third valve 33 is opened and the first valve 31 is closed (step 210). If the supply takes place in stage 2, the pressure level PG₂ is monitored (step 211). If the pressure drops to PG₂ or below the second minimum pressure level P_{high} (high-pressure storage tank 22 emptied), the engine 100 is stopped (step 212), as the two required injection pressures can no longer be provided by the storage device 10.

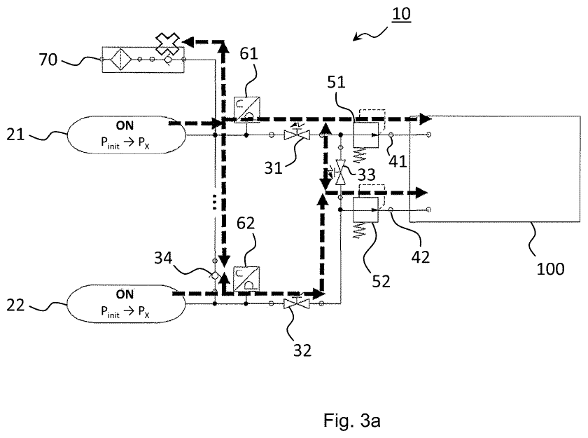

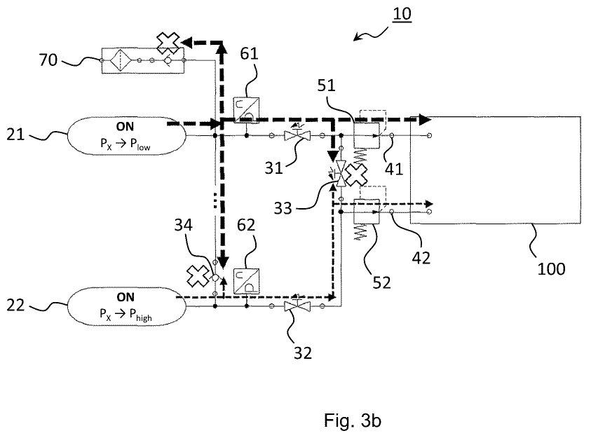

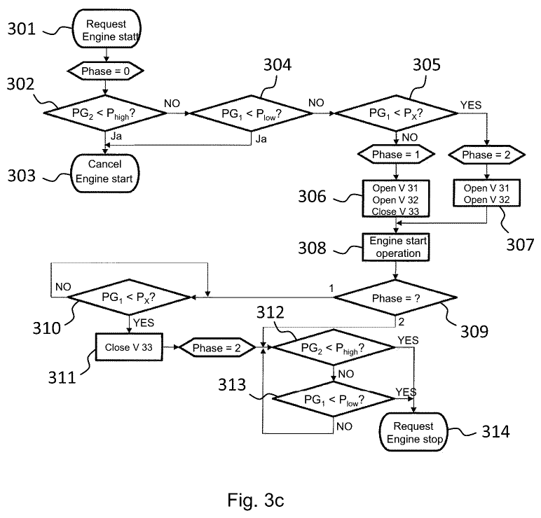

FIGS. 3a-b show a second exemplary embodiment, wherein the storage device 10 is constructed in the same way as that of the first exemplary embodiment. However, the switching positions of the valves 31, 32, 33 differ in the first and second stages of the supply to the consumer. In this exemplary embodiment, in a first stage the low and high-pressure storage tanks 21, 22 jointly supply both connections 41, 42 up to a defined intermediate pressure level P_{X}.

The first stage is shown in FIG. 3a. Said stage is characterized by the fact that the pressure level detected by the first pressure sensor 61 PG₁ above the defined intermediate pressure level P_{X} is above the defined intermediate pressure level. Alternatively, the second pressure level detected by the second pressure sensor 62 could also be PG₂ could also be considered. The intermediate pressure level P_{X} is above the second minimum pressure level P_{high} and depends on the design of the storage device 10 (e.g. the capacities of the low and high-pressure storage tanks 21, 22, the design of the first and second valves 31, 32 and the values of the minimum pressure levels P_{low}, P_{high}). All switchable valves 31, 32, 33 are open so that the pressure in the low-pressure range and in the high-pressure range is balanced and both connections 41, 42 are supplied together.

When the system pressure reaches the defined intermediate pressure level P_{X} the second stage is entered (see FIG. 3b) and the third valve 33 is closed. This results in the switching position of the first stage according to the first exemplary embodiment (see FIG. 2c). The low-pressure connection 41 is only supplied by the low-pressure storage tank 21 and the latter is emptied to the first minimum pressure level P_{low}. The high-pressure connection 42 is supplied separately only from the high-pressure storage tank 22 and the latter is emptied to the second minimum pressure level P_{high}. The intermediate pressure level P_{X} is optionally selected so that the low-pressure storage tank 21 and the high-pressure storage tank 22 reach their respective minimum pressure levels P_{low}, P_{high} at the same time.

FIG. 3c uses a flow chart to show an exemplary embodiment of a method that can be performed for operating the consumer 100, which is configured as a gas engine, using the storage device of FIGS. 3a-b.

After a request to start the engine (step 301), it is checked (in particular by the aforementioned control unit) whether the pressure level PG₂ is above the second minimum pressure level P_{high} (step 302). If NO, the storage device 10 or the high-pressure storage tank 22 is considered to be empty and the engine start is aborted (step 303). If YES, it is checked whether the pressure level PG₁ is above the first minimum pressure level P_{low} (step 304). If NO, the engine stop is also canceled (step 303). If YES, it is checked whether the pressure level PG₁ is above the defined intermediate pressure level P_{X} (step 305). If this is the case, the supply is carried out using stage 1 shown in FIG. 3a, i.e. valves 31 and 32 are open and valve 33 is closed (step 306). If the pressure level PG₁ is not above the defined intermediate pressure level P_{X} stage 2 shown in FIG. 3b is used for the supply, i.e. valves 31, 32 are open while valves 33, 34 are closed (step 307). After switching the corresponding valves 31, 32, 33 (step 306 or 307), the engine 100 is started (step 308) and is supplied with the corresponding injection pressures. Checking the pressure levels PG₁ and PG₂ can be carried out simultaneously.

During engine operation, the pressures PG₁ and PG₂ are recorded and compared with the corresponding limit values P_{X}, P_{low} and P_{high} in regular intervals, depending on which stage the system is in (step 309). If the supply takes place in stage 1, the pressure level is PG₁ is monitored (step 310). If the pressure PG₁ drops to or below the intermediate pressure level P_{X}, stage 2 is entered and the third valve 33 is closed (step 311). In stage 2, the pressure level is PG₂ monitored to see whether it is above the second minimum pressure level P_{high} (step 312). If the pressure PG₂ drops to or below the second minimum pressure level P_{high} (high-pressure storage tank 22 emptied), the engine 100 is stopped (step 314), as the high-pressure connection 42 can no longer be supplied with the required injection pressure. In addition, the pressure level is PG₁ monitored to see whether it is above the first minimum pressure level P_{low} (step 313). If the pressure PG₁ drops to or below the first minimum pressure level P_{low} (low-pressure storage tank 21 emptied), the engine 100 is stopped (step 314), as the low-pressure connection 41 can no longer be supplied with the required injection pressure.

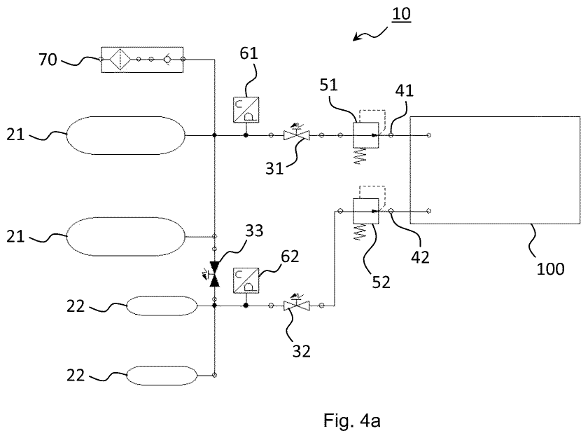

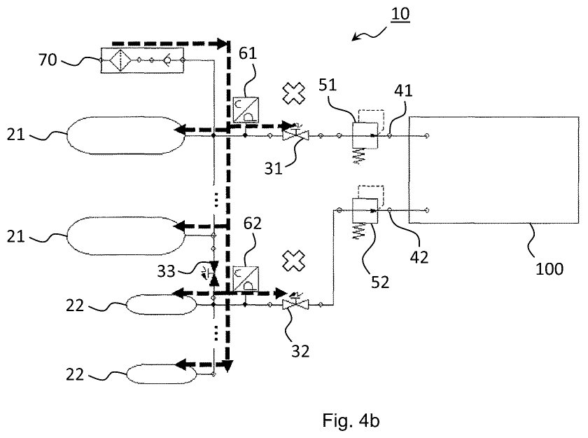

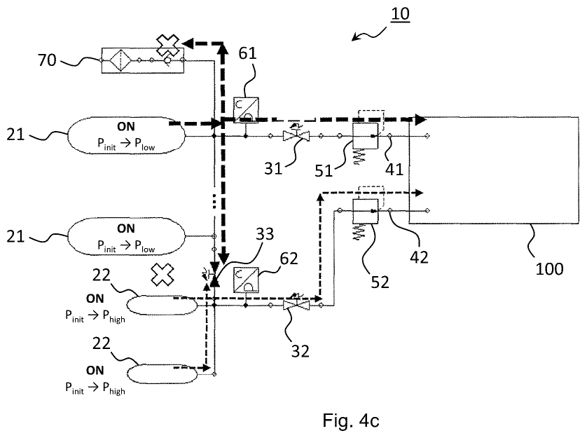

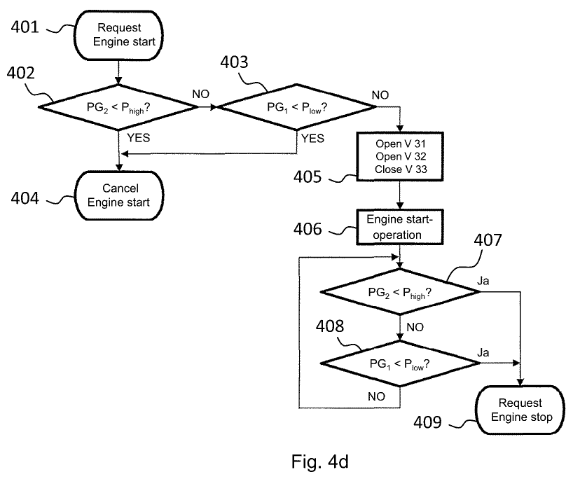

FIGS. 4a-c show a third exemplary embodiment of the storage device 10 according to the disclosure. In contrast to the first two embodiments, the pressure reducers 51, 52 and the connections 41, 42 are not connected to each other via a bypass valve. In addition, the low and high-pressure storage tanks 21, 22 are not connected to each other via a non-return valve, but via a switchable third valve 33, i.e. the low and high pressure areas can be actively separated from each other (in particular by activating the third valve 33 via a control unit) or connected to each other. In the exemplary embodiment shown here, two low-pressure storage tanks 21 and two high-pressure storage tanks 22 are provided. However, a different number of low-pressure and/or high-pressure storage tanks 21, 22 can be used in each case (i.e. only one or more than two). Furthermore, the low and high-pressure storage tanks 21, 22 have different capacities in this exemplary embodiment. In an alternative embodiment, the third valve 33 could be configured as a non-return valve. A design as a manually switchable shut-off valve is also conceivable in principle.

FIG. 4b again shows the filling method via the common gas inlet 70. For this purpose, the first and second valves 31, 32 are closed, while the third valve 33 is open.

The consumer 100 is only supplied in a single stage, which is shown in FIG. 4c. The first and second valves 31, 32 are open, while the third valve 33 is closed. This means that the low-pressure connection 41 is only supplied via the low-pressure storage tanks 21 and the high-pressure connection 42 is only supplied separately via the high-pressure storage tanks 22. If the pressure level detected by the first pressure sensor 61 falls PG₁ to or below the first minimum pressure level P_{low} or if the pressure level detected by the second pressure sensor 62 falls PG₂ to or below the second minimum pressure level P_{high} the storage device 10 is emptied. The storage tanks 21, 22 are optionally configured (via their number and/or capacity) in such a way that the consumer 100 is optimally supplied and, in particular, the low-pressure storage tanks 21 and the high-pressure storage tanks 22 are empty at the same time.

FIG. 4d uses a flow diagram to illustrate an exemplary embodiment of a method for operating the consumer 100, which is configured as a gas engine, using the storage device of FIG. 4a-c.

After an engine start request (step 401), it is checked (in particular by the aforementioned control unit) whether the pressure level PG₂ is above the second minimum pressure level P_{high} (step 402) and whether the pressure level PG₁ is above the first minimum pressure level P_{low} (step 403). If the respective minimum pressure level P_{low}, P_{high} is reached in the low-pressure range or in the high-pressure range, the storage device 10 is to be regarded as empty and the engine start is aborted (step 404). If both the pressure level PG₁ above the first minimum pressure level P_{low} as well as the pressure level PG₂ above the first minimum pressure level P_{high}, the motor 100 is supplied as shown in FIG. 4c, i.e. the valves 31, 32 are open and the valve 33 is closed (step 405). After switching the corresponding valves 31, 32, 33, the engine 100 is started (step 406) and this is supplied with the corresponding injection pressures. Checking the pressure levels PG₁ and PG₂ can be carried out simultaneously.

During engine operation, the pressures PG₁ and PG₂ are recorded and compared with the corresponding minimum pressure levels P_{low} and P_{high} (steps 407 and 408). If the pressure falls PG₁ to or below the first minimum pressure level P_{low} or if the pressure falls PG₂ to or below the second minimum pressure level P_{high} the engine 100 is stopped (step 409), as the corresponding connection 41, 42 can no longer be supplied with the required injection pressure.

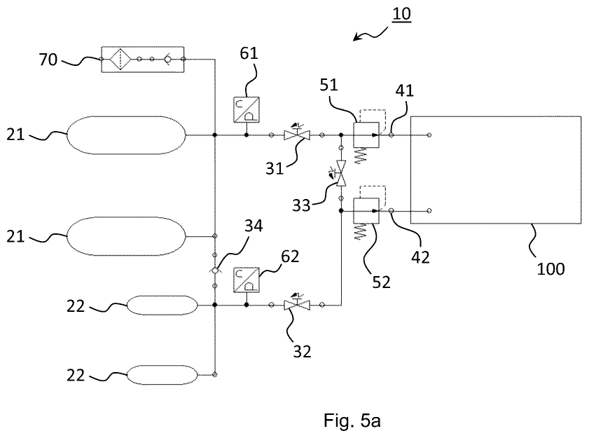

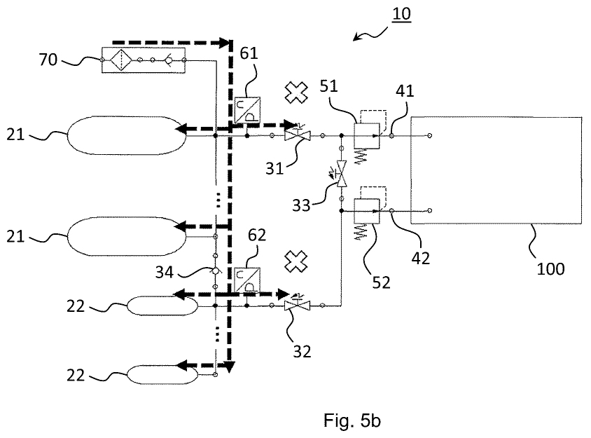

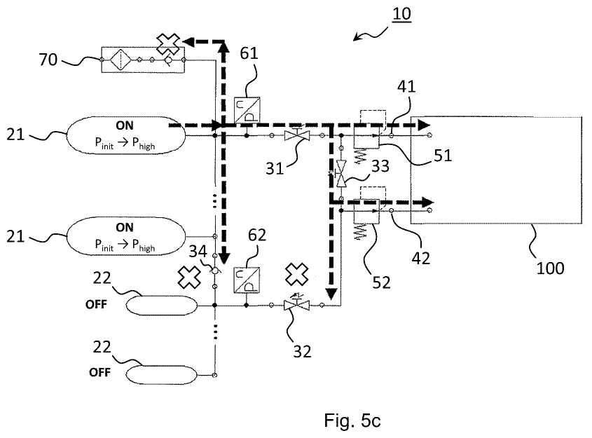

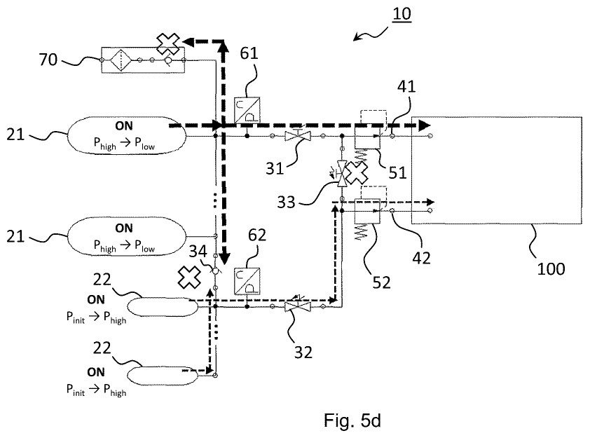

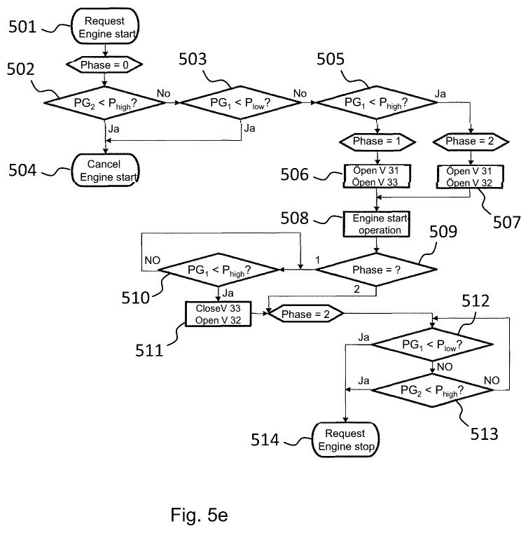

FIGS. 5a-d show a fourth exemplary embodiment of the storage device 10 according to the disclosure. This exemplary embodiment represents a combination of the storage devices 10 of the previous exemplary embodiments. Except for the gas storage tanks 21, 22, the storage device 10 is constructed similar to that of the first two exemplary embodiments, i.e. a third valve 33 is provided as a bypass valve and a non-return valve is provided as a fourth valve 34 (see FIG. 5a). In this exemplary embodiment, two low-pressure storage tanks 21 and two high-pressure storage tanks 22 are provided in each case (the notes on their number and design with regard to the third exemplary embodiment apply analogously to this exemplary embodiment).

FIG. 5b again shows the filling method via the common gas inlet 70. For this purpose, the first and second valves 31, 32 are closed, optionally also the third valve 33. The non-return valve 34 is open due to the pressure of the gas introduced via the gas inlet 70.

FIGS. 5c-d show two stages of the supply operation of the storage device 10 for the consumer 100, which allows the low-pressure storage tanks 21 to be emptied to the lower first minimum pressure level P_{low} pressure level than the high-pressure storage tanks 22, which are emptied to the higher second minimum pressure level P_{high}.

The first stage is shown in FIG. 5c. Both connections 41, 42 are only supplied via the low-pressure storage tanks 21. The second valve 32 is closed for this purpose. Due to the pressure difference between the low and high pressure areas, the non-return valve 34 is also closed. The high-pressure storage tanks 22 are therefore not emptied. The supply via the low-pressure storage tanks 21 continues until the pressure level measured by the first pressure sensor 61 PG₁ (i.e. the pressure prevailing in the low-pressure range) reaches the second minimum pressure level P_{high} for the high-pressure connection 42.

The storage device 10 then enters the second stage (see FIG. 5d), in which the low-pressure storage tanks 21 are pressurized from the pressure P_{high} to the first minimum pressure level P_{low} and the high-pressure storage tanks 22 from the initial pressure Pᵢₙᵢₜ to the second minimum pressure level P_{high} are emptied. For this purpose, the second valve 32 is opened and the third valve 33 is closed so that there are two separate supply circuits (the non-return valve 34 is still closed due to the pressure difference). If the pressure level detected by the first pressure sensor 61 falls PG₁ to or below the first minimum pressure level P_{low} or if the pressure level detected by the second pressure sensor 62 falls PG₂ to or below the second minimum pressure level P_{high} the storage device 10 is emptied. The gas storage tanks 21, 22 are optionally configured (via their number and/or capacity) in such a way that the consumer 100 is optimally supplied and, in particular, the low-pressure storage tanks 21 and the high-pressure storage tanks 22 are empty at the same time. Again, the first and second valves 31, 32 and/or the first and second pressure reducers 51, 52 are optionally configured such that the mass flow through the second valve 32 is less than the mass flow through the first valve 31, so that the non-return valve 34 remains closed due to the resulting pressure difference.

FIG. 5e uses a flow diagram to show an exemplary embodiment of a method for operating the consumer 100, which is configured as a gas engine, using the storage device of FIGS. 5a-d.

After a request to start the engine (step 501), it is checked (in particular by the aforementioned control unit) whether the pressure level PG₂ is above the second minimum pressure level P_{high} (step 502) and whether the pressure level PG₁ is above the first minimum pressure level P_{low} (step 503). If the respective minimum pressure levels P_{low}, P_{high} are reached in the low pressure range or in the high pressure range, the storage device 10 is considered to be empty and the engine start is aborted (step 504). If the pressure levels PG₁ and PG₂ are above the respective minimum pressure levels P_{low}, P_{high}, the type of supply to the consumer 100 depends on whether the pressure level PG₁ in the low-pressure range is greater than or less than (or equal to) the second minimum pressure level P_{high} (step 505). If the pressure level is PG₁ is above P_{high}, the supply takes place in accordance with stage 1 shown in FIG. 5c, i.e. the first and third valves 31, 33 are open, while the second and fourth valves 32, 34 are closed (step 506). The low-pressure storage tanks 21 are then emptied to the second minimum pressure level P_{high}. Otherwise, the supply takes place according to stage 2 shown in FIG. 5d, i.e. the first and second valves 31, 32 are open, while the third valve 33 (as well as the fourth valve 34) are closed (step 507). After switching the corresponding valves 31, 32, 33 (step 506 or 507), the engine 100 is started (step 508) and this is supplied with the corresponding injection pressures. Checking the pressure levels PG₁ and PG₂ can be carried out simultaneously.

During engine operation, the pressures PG₁ and PG₂ are recorded and compared with the corresponding limit values P_{low} and P_{high} depending on which stage the system is in (step 509). If the supply takes place in stage 1, the pressure level is PG₁ is monitored (step 510). If the pressure falls PG₁ falls to or below the second minimum pressure level P_{high}, stage 2 is entered and the second valve 32 is opened and the third valve 33 is closed (step 511). In stage 2, the pressure level is monitored PG₁ monitored to see whether it is above the first minimum pressure level P_{low} (step 512) and, on the other hand, the pressure level is PG₂ whether it is above the second minimum pressure level (step 513). P_{high} (step 513). If the pressure PG₁ in the low pressure range falls to or below the first minimum pressure level P_{low}(low-pressure storage tank 21 emptied) or if the pressure in the high-pressure PG₂ in the high pressure range to or below the second minimum pressure level P_{high} (high-pressure storage tank 22 emptied), the engine 100 is stopped (step 514), as the connections 41, 42 can no longer both be supplied with the required injection pressure.

### List of Reference Characters

1 Gas storage tank
2 Gas storage tank
3 Valve
4 Pressure reducing valve
5 Pressure reducing valve
6 Pressure sensor
7 Gas inlet
8 Low-pressure connection
9 High-pressure connection
10 Storage device
21 Low-pressure storage tank
22 High-pressure storage tank
31 First valve
32 Second valve
33 Third valve
34 Fourth valve
41 Low-pressure connection
42 High-pressure connection
51 First pressure reducing valve
52 Second pressure reducing valve
61 First pressure sensor
62 Second pressure sensor
70 Gas inlet
100 Consumers
P_{low} First minimum pressure level or gas pressure level (lower injection pressure)
P_{high} Second minimum pressure level or gas pressure level (higher injection pressure)
Pᵢₙᵢₜ Initial pressure level in the storage device after filling
P_{X} Intermediate pressure level
PG₁ Pressure level detected by the first pressure sensor
PG₂ Pressure level detected by the second pressure sensor

1. Storage device for storing a gas and supplying a consumer with different gas pressure levels, comprising at least one low-pressure storage tank and at least one high-pressure storage tank,
wherein
the low-pressure storage tank is connected to a low-pressure connection via a switchable first valve and the high-pressure storage tank is connected to a high-pressure connection via a switchable second valve, wherein a higher gas pressure level can be made available to a connected consumer via the high-pressure connection than via the low-pressure connection,
the low-pressure connection and the high-pressure connection are connected to each other via a switchable third valve,
the low-pressure storage tank and the high-pressure storage tank are connected to each other via a fourth valve, and
the valves are switchable in such a way that the low-pressure storage tank can be emptied to a lower minimum pressure level than the high-pressure storage tank.

2. Storage device according to claim 1, further comprising a first pressure reducing valve connected to the low-pressure connection and a second pressure reducing valve connected to the high-pressure connection, wherein the first pressure reducing valve provides a defined first gas pressure level at the low-pressure connection, which is lower than a second gas pressure level provided via the second pressure reducing valve at the high-pressure connection.

3. Storage device according to claim 1, wherein the fourth valve is a non-return valve which separates a low-pressure region formed between the low-pressure storage tank and the first valve from a high-pressure region formed between the high-pressure storage tank and the second valve and is configured to block a gas flow from the high-pressure region into the low-pressure region.

4. Storage device according to claim 1, wherein the low-pressure and high-pressure storage tanks are connected to a common gas inlet and can be jointly filled with gas via the latter.

5. Storage device according to the preamble of claim 1, wherein the low-pressure storage tank is connected to a low-pressure connection via the switchable first valve and the high-pressure storage tank is connected to a high-pressure connection via the switchable second valve, wherein a higher gas pressure level can be made available to a connected consumer via the high-pressure connection than via the low-pressure connection, wherein the low-pressure storage tank and the high-pressure storage tank are connected to one another via the third valve and wherein the valves are switchable in such a way that the low-pressure storage tank can be emptied to a lower minimum pressure level than the high-pressure storage tank.

6. Storage device according to claim 1, wherein the low-pressure connection and the high-pressure connection are connected to one another only via the third valve.

7. Storage device according to claim 1, wherein a first pressure sensor is arranged in a low-pressure region between the low-pressure storage tank and the first valve, which first pressure sensor detects the pressure level in the low-pressure region, and a second pressure sensor is arranged in a high-pressure region between the high-pressure storage tank and the second valve, which second pressure sensor detects the pressure level in the high-pressure region.

8. Storage device according to claim 7, further comprising a control unit which is connected to the first, second and third valves and is configured to switch them independently of one another.

9. Storage device according to claim 8, wherein the control unit is connected to the first and second pressure sensors and is configured to switch the first, second and third valves automatically as a function of the pressures detected via the pressure sensors in such a way that the low-pressure storage tank is emptied to a first minimum pressure level and the high-pressure storage tank is emptied to a second minimum pressure level, wherein the second minimum pressure level is above the first minimum pressure level, while simultaneously supplying pressure to the low- and high-pressure connections.

10. Storage device according to claim 8, wherein the first and second valves and/or the first and second pressure reducing valves are configured such that a gas flow through the first valve is greater than a gas flow through the second valve.

11. Working equipment, comprising a storage device according to claim 1, and a consumer, which comprises a low-pressure inlet connected to the low-pressure connection of the storage device and a high-pressure inlet connected to the high-pressure connection of the storage device, via which the consumer can be supplied with different gas pressure levels.

12. Method for supplying a consumer, with different gas pressure levels by means of a storage device according to claim 1, wherein a first pressure is measured in a low-pressure region between the low-pressure storage tank and the first valve and a second pressure is measured in a high-pressure region between the high-pressure storage tank and the second valve, and the valves are switched as a function of the measured pressures in such a way that the low-pressure storage tank can be emptied to a first minimum pressure level and the high-pressure storage tank can be emptied to a second minimum pressure level, wherein the second minimum pressure level is higher than the first minimum pressure level.

13. Method according to claim 12, wherein the first and second valves are opened and the third and fourth valves are closed when the first measured pressure is greater than the first minimum pressure level, so that the low-pressure storage tank can be emptied to the first minimum pressure level, wherein the second and third valves are open and the first and fourth valves are closed when the first measured pressure is less than or equal to the first minimum pressure level, so that the high-pressure storage tank can be emptied to the second minimum pressure level.

14. Method according to claim 12,, wherein the first, second and third valves are opened when the first measured pressure and/or the second measured pressure is greater than a defined intermediate pressure level, which is above the second minimum pressure level, so that the low and high-pressure storage tanks can be emptied to the intermediate pressure level, wherein the first and second valves are open and the third and fourth valves are closed, when the first measured pressure and/or the second measured pressure is less than or equal to the intermediate pressure level, so that the low-pressure storage tank can be emptied to the first minimum pressure level and the high-pressure storage tank can be emptied to the second minimum pressure level.

15. Method according to claim 12, wherein the first and third valves are opened and the second and fourth valves are closed when the first measured pressure is greater than the second minimum pressure level so that the low-pressure storage tank can be emptied to the second minimum pressure level, wherein the first and second valves are open and the third and fourth valves are closed when the first measured pressure is less than or equal to the second minimum pressure level, so that the low-pressure storage tank can be emptied to the first minimum pressure level and the high-pressure storage tank can be emptied to the second minimum pressure level.

16. Method according to claim 12, wherein first and second valves are open and the third valve is closed so that the low-pressure storage tank can be emptied to the first minimum pressure level and the high-pressure storage tank can be emptied to the second minimum pressure level.

17. Method according to claim 12, wherein the supply to the consumer is stopped once the first measured pressure reaches or falls below the first minimum pressure level or the second measured pressure reaches or falls below the second minimum pressure level in the case of low-pressure and high-pressure connections which are separated from one another in a gas-tight manner, or once the second measured pressure reaches or falls below the second minimum pressure level in the case of low-pressure and high-pressure connections which are connected to one another in a gas-conducting manner.

18. Storage device according to claim 4, wherein the fourth valve is configured to automatically open when filling with gas and to connect the low-pressure and high-pressure storage tanks to one another in a gas-conducting manner.

19. Storage device according to claim 9, wherein the first, second and third valves are configured as solenoid valves.

20. Storage device according to claim 11 wherein the working equipment is a gas-operated motor.
